(19) United States
(12) Patent Application Publication
(10) Pub. No.: US 2014/0247620 A1
(43) Pub. Date: Sep. 4, 2014

(54) DISPLAY APPARATUS

(71) Applicant: Funai Electric Co., Ltd., Osaka (JP)

(72) Inventors: Hiromasa SASAOKA, Osaka (JP); Naoki HONGO, Osaka (JP)

(73) Assignee: Funai Electric Co., Ltd., Osaka (JP)

(21) Appl. No.: 14/183,585

(22) Filed: Feb. 19, 2014

(30) Foreign Application Priority Data
Mar. 1, 2013 (JP) 2013-041271

(51) Int. Cl. F21V 8/00; F21V 29/00

(52) U.S. Cl. CPC G02B 6/0033; F21V 29/22
USPC 362/611

(57) ABSTRACT

A display apparatus includes an LCD panel, a resin rear cabinet facing a back of the LCD panel, and a backlight unit that is supported by the rear cabinet. The backlight unit includes a light source, a light guide plate into which light from the light source enters through a side surface and exits through a main surface toward the back of the LCD panel, and a heat sink supported by the rear cabinet and attached to the light source. The rear cabinet includes an integrally formed resin protrusion passing through the heat sink and supporting the light guide plate, and positioning of the light source is determined by a contact surface thereof with the heat sink and positioning of the light guide plate is determined by a contact surface thereof with the protrusion so that optical axes of the light source and the light guide plate are aligned.

### CROSS REFERENCE TO RELATED APPLICATION

The present application is based on and claims priority of Japanese Patent Application No. 2013-041271 filed on Mar. 1, 2013. The entire disclosure of the above-identified application, including the specification, drawings and claims is incorporated herein by reference in its entirety.

### FIELD

The present invention relates to display apparatuses for displaying images.

### BACKGROUND

Conventional display apparatuses include those equipped with edge-lit backlight units which shine light toward the back surface of the display panel, such as those found in liquid crystal television receivers (for example, see Patent Literature 1).

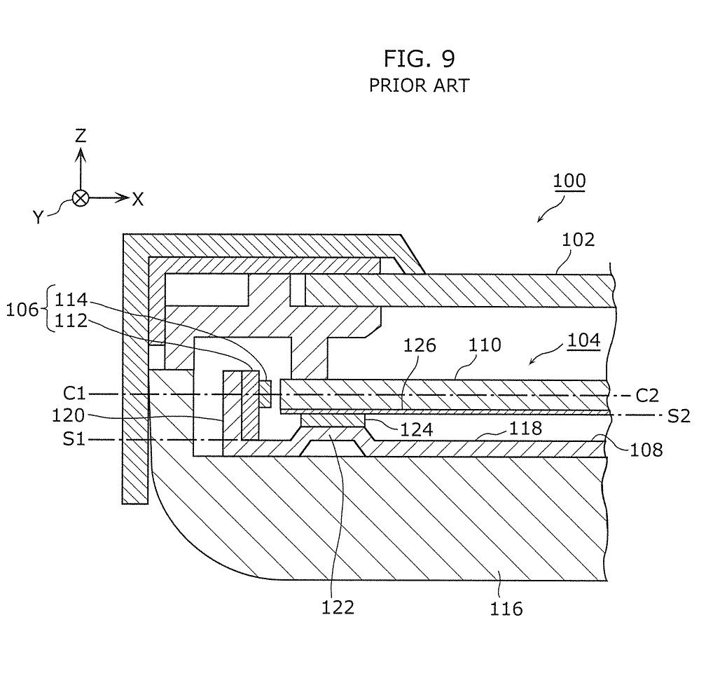

FIG. 9 shows a cross section of the relevant portion of a conventional display apparatus. The display apparatus 100 shown in FIG. 9 is provided with an edge-lit backlight unit 104 behind the display panel 102. The backlight unit 104 includes a light source 106, a heat sink 108, and a light guide plate 110. The light source 106 includes a wiring substrate 112 and a plurality of light emitting diodes (LEDs) 114 mounted on the wiring substrate 112. The heat sink 108 includes a heat dissipation portion 118 supported by a rear cabinet 116 and an attachment portion 120 which extends from one end of the heat dissipation portion 118 toward the display panel 102. The heat sink 108 is made from a metal having high thermal conductivity, such as aluminum, The heat dissipation portion 118 includes a protrusion 122 which is bent to protrude toward the display panel 102. The protrusion 122 supports the light guide plate 110 with a cushion 124 therebetween. The wiring substrate 112 is attached to the attachment portion 120, and the plurality of LEDs 114 are arranged to face the side surfaces of the light guide plate 110. It should be noted that a reflective sheet 126 for reflecting light is attached to the back surface of the light guide plate 110.

Positioning in the Z axis direction of each of the plurality of LEDs 114 is determined by a contact surface S1 of the wiring substrate 112 and the heat dissipation portion 118. Positioning of the light guide plate 110 in the Z axis direction is determined by a contact surface S2 thereof with the cushion 124. With this, an optical axis C1 of each of the plurality of LEDs 114 and an optical axis C2 of the light guide plate 110 are aligned.

### CITATION LIST

### Patent Literature

[PTL 1] Japanese Unexamined Patent Application Publication No. 2003-279973

### SUMMARY

### Technical Problem

The following problem has been found with the above-described conventional display apparatus 100. The shape of the heat sink 108 is over complicated since the protrusion 122 is formed on the heat dissipation portion 118, contributing to a decrease in build quality of the heat sink 108. As such, there is a problem that inconsistencies in the positioning of the light guide plate 110 in the Z axis direction easily arise, and the optical axis C1 of each of the plurality of LEDs 114 and the optical axis C2 of the light guide plate 110 can easily become offset.

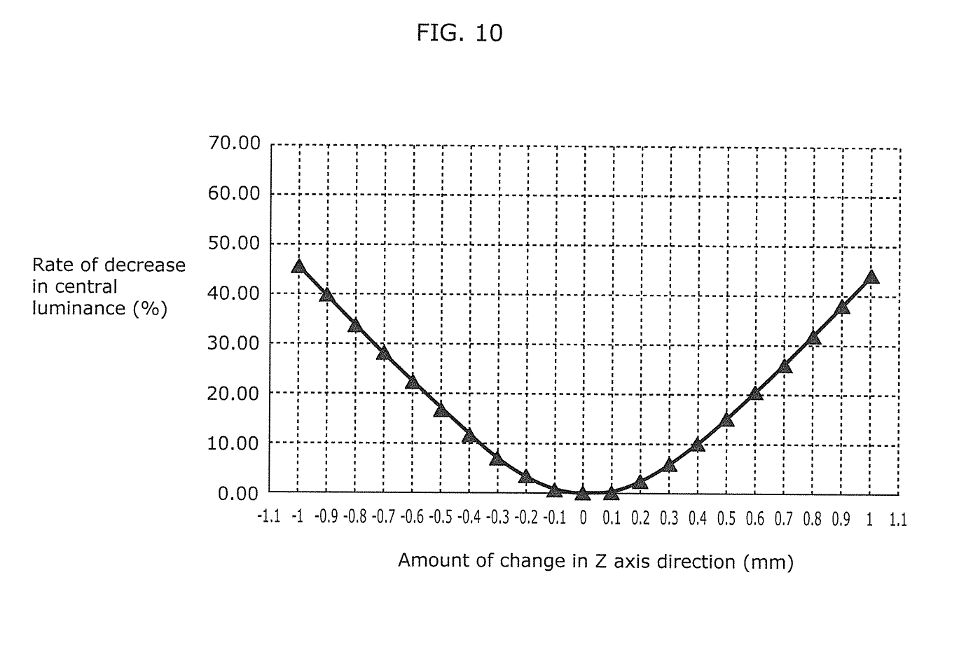

FIG. 10 is a graph showing the relationship between (i) an amount of change in the Z axis direction of the optical axis of the light guide plate relative to the optical axis of the LED and (ii) the rate of decrease in central luminance in the display panel. As FIG. 10 shows, the rate of decrease in central luminance in the display panel 102 increases with an increase in the amount of change in the Z axis direction of the optical axis C2 of the light guide plate 100 relative to the optical axis C1 of the LED 114. As such, in the conventional display apparatus 100, the large positional offset between the optical axis C1 of each of the plurality of LEDs 114 and the optical axis C2 of the light guide plate 110 is cause for concern that the central luminance in the display panel 102 will greatly decrease.

It should be noted that in addition the configuration shown in FIG. 9, configurations of the conventional display apparatus include a configuration in which a resin positioning member is provided between the light guide plate and the display panel, and positioning of the light guide plate in the Z axis direction is determined by the contact surface of this positioning member and the light guide plate. However, with this configuration and the provision of the positioning member, the number of components used to position the light guide plate in the Z axis direction increases. This leads to the same problem in positional deviation since the tolerance stack for the components increases.

The present invention aims to solve the above-described problem and provide a display apparatus capable of minimizing a misalignment of the optical axes of the light source and the light guide plate.

### Solution to Problem

In order to solve the above-described problem, a display apparatus according to an aspect of the present invention includes: a display panel; a resin support member facing a back surface of the display panel; and a backlight unit that is supported by the support member and emits light toward the back surface of the display panel, the backlight unit including: a light source that generates the light; a light guide plate including a side surface through which the light generated by the light source enters and a main surface through which the light entering through the side surface exits toward the back surface of the display panel; and a heat sink supported by the support member and to which the light source is attached, wherein the support member includes an integrally formed resin protrusion passing through the heat sink and supporting the light guide plate, and positioning of the light source is determined by a contact surface thereof with the heat sink and positioning of the light guide plate is determined by a contact surface thereof with the protrusion so that optical axes of the light source and the light guide plate are aligned.

According to this aspect, it is possible to relatively accurately form the protrusion since the protrusion and the support member are integrally formed from resin. Moreover, a discrepancy in the position of the light guide plate in a predetermined direction (for example, in the thickness direction of the display apparatus) can be reduced since positioning of the light guide plate is determined by the contact surface thereof with the protrusion, thereby minimizing a misalignment of the optical axes of the light source and the light guide plate.

For example, in the display apparatus according to an aspect of the present invention, the heat sink may include: a heat dissipation portion supported by the support member; and an attachment portion that extends from an end portion of the heat dissipation portion toward the display panel and to which the light source is attached, the protrusion may pass through the heat dissipation portion and supports the light guide plate, and positioning of the light source may be determined by a contact surface thereof with the heat dissipation portion.

According to this aspect, efficient dissipation of eat from the light source is possible due to the heat from the light source transferring to the heat dissipation portion via the attachment portion.

For example, in the display apparatus according to an aspect of the present invention, the protrusion may include a spacer disposed between the light source and the side surface of the light guide plate.

According to this aspect, the distance between the light source and a side surface of the light guide plate can be kept constant due to the provision of the spacer between the light source and a side surface of the light guide plate.

For example, in the display apparatus according to an aspect of the present invention, the protrusion may have a surface in contact with the light guide plate, and at least a portion of an edge of the surface may be rounded.

According to this aspect, pressure at the contact surface of the protrusion and the light guide plate can be kept to a relative minimum due to at least a portion of the edge being rounded.

For example, in the display apparatus according to an aspect of the present invention, the support member may include a plurality of the protrusions, and the plurality of the protrusions may be spaced apart from each other.

According to this aspect, provision of a plurality of the protrusions on the support member allows for the light guide plate to be stably supported thereby.

For example, in the display apparatus according to an aspect of the present invention, a bend preventing member for preventing the light guide plate from bending toward the heat sink may be provided on the heat sink between two adjacent ones of the plurality of the protrusions.

According to this aspect, the light guide plate can be kept from bending toward the heat sink with the provision of the bend preventing member on the heat sink between two adjacent protrusions.

For example, the display apparatus according to an aspect of the present invention may further include a housing containing the display panel and the backlight unit, wherein the housing includes: a front cabinet arranged on a side of the display apparatus that the display panel is situated; and a rear cabinet arranged on a side of the display apparatus that the backlight unit is situated, and the support member is the rear cabinet.

According to this aspect, the number of components in the display apparatus can be reduced since the rear cabinet functions as the support member.

### Advantageous Effects

With the present invention, it is possible to minimize a misalignment of the optical axes of the light source and the light guide plate.

### BRIEF DESCRIPTION OF DRAWINGS

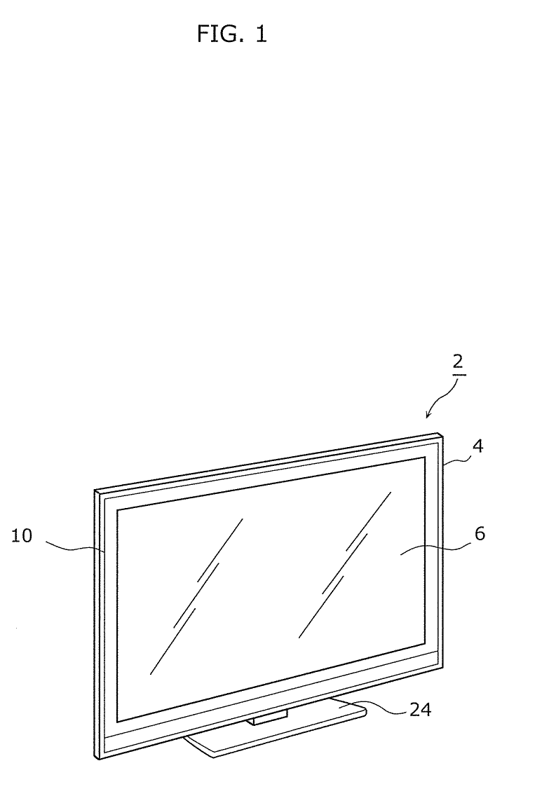

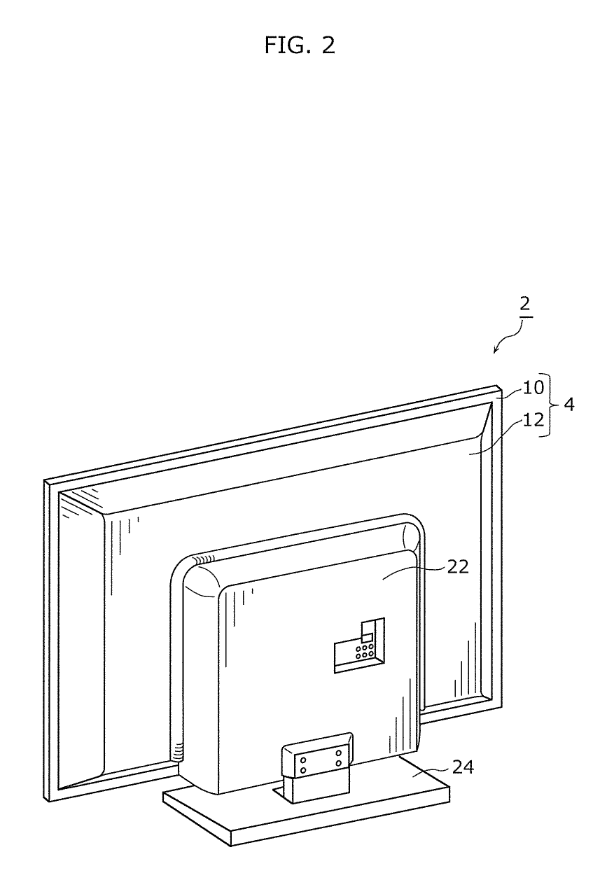

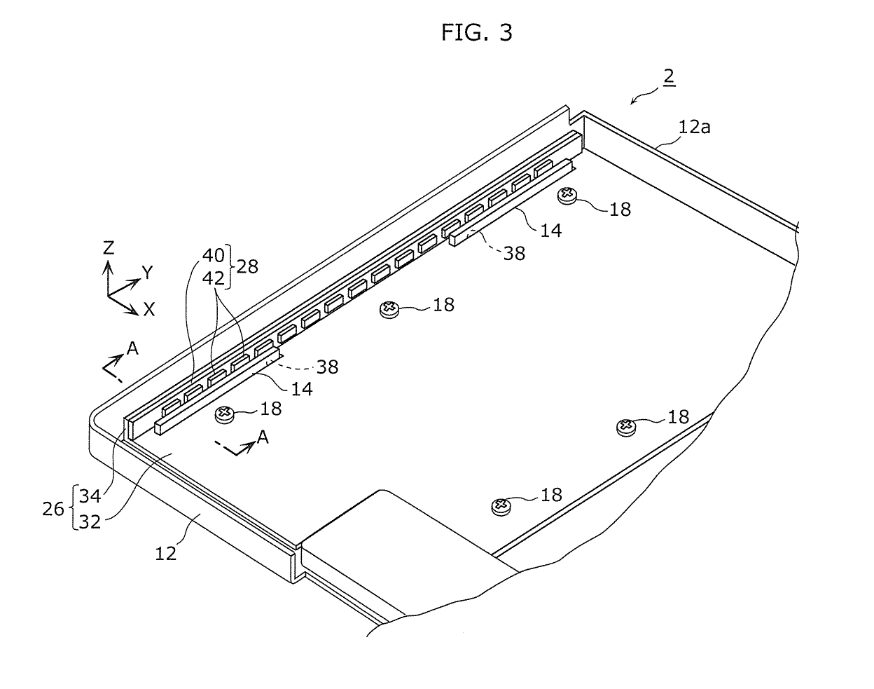

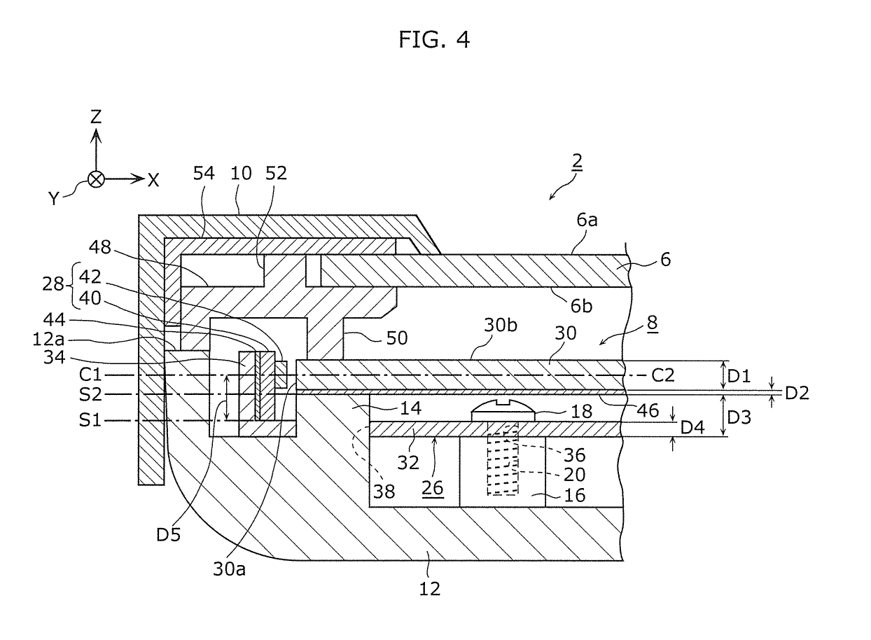

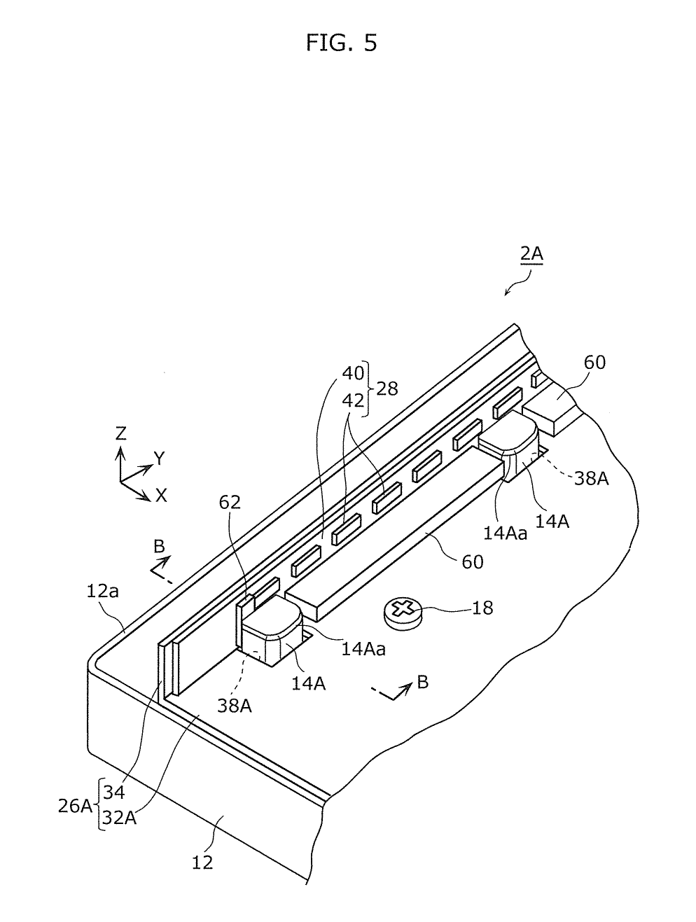

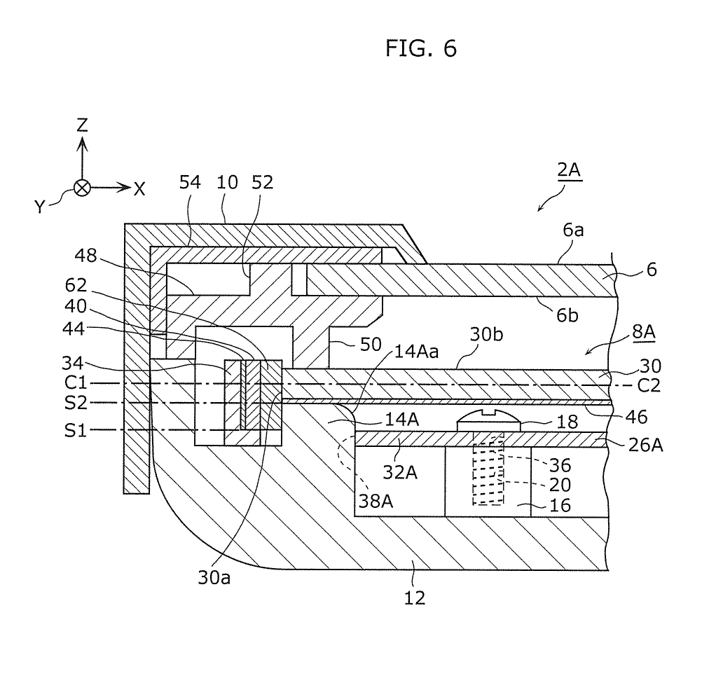

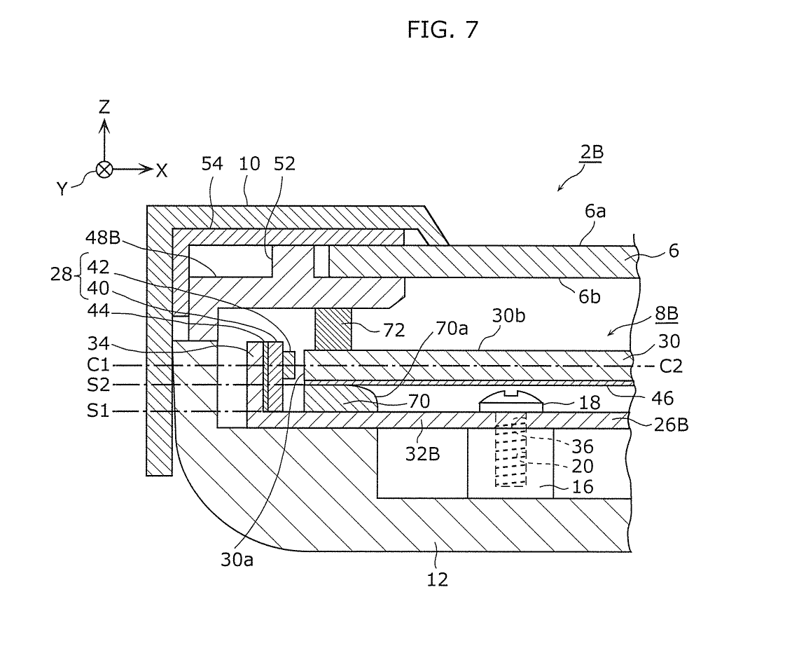

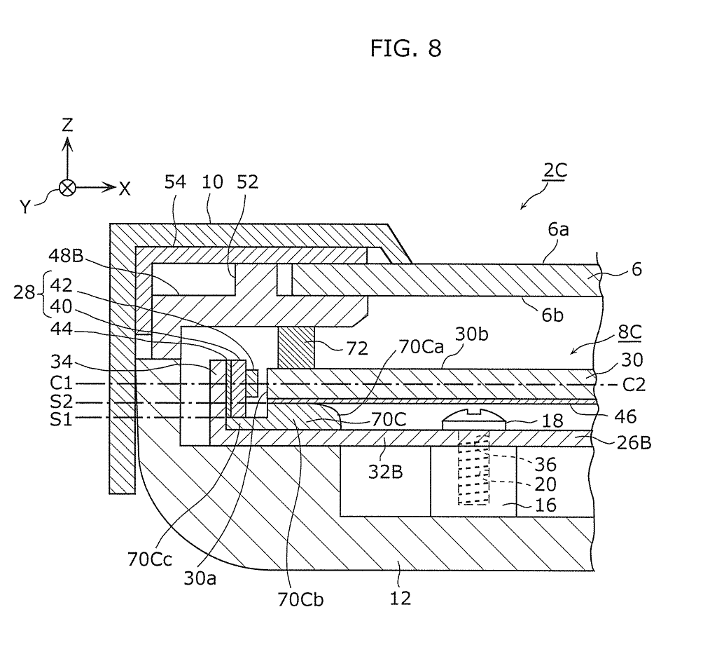

These and other objects, advantages and features of the invention will become apparent from the following description thereof taken in conjunction with the accompanying drawings that illustrate a specific embodiment of the present invention.

[FIG. 1] FIG. 1 is a perspective view of the front of the display apparatus according to Embodiment 1 of the present invention.

[FIG. 2] FIG. 2 is a perspective view of the back of the display apparatus shown in FIG. 1.

[FIG. 3] FIG. 3 is a perspective view showing the internal structure of the display apparatus shown in FIG. 1.

[FIG. 4] FIG. 4 is a cross section showing the relevant components in the display apparatus at the line A-A shown in FIG. 3.

[FIG. 5] FIG. 5 is a perspective view showing part of the internal structure of the display apparatus according to Embodiment 2 of the present invention.

[FIG. 6] FIG. 6 is a cross section showing the relevant components in the display apparatus at the line B-B shown in FIG. 5.

[FIG. 7] FIG. 7 is a cross section showing the relevant components in the display apparatus according to Embodiment 3 of the present invention.

[FIG. 8] FIG. 8 is a cross section showing the relevant components in the display apparatus according to Embodiment 4 of the present invention.

[FIG. 9] FIG. 9 is a cross section showing the relevant portion of a conventional display apparatus.

[FIG. 10] FIG. 10 is a graph showing the relationship between (i) an amount of change in the Z axis direction of the optical axis of the light guide plate relative to the optical axis of the LED and (ii) the rate of decrease in central luminance in the display panel.

### DESCRIPTION OF EMBODIMENTS

Hereinafter, certain exemplary embodiments are described in greater detail with reference to the accompanying Drawings. It should be noted the embodiments described below show a specific example of the present invention. The numerical values, shapes, materials, structural elements, the arrangement and connection of the structural elements etc. shown in the following exemplary embodiments are mere examples, and therefore do not limit the present invention, the scope of which is defined in the appended Claims. As such, among the structural elements in the following exemplary embodiments, structural elements not recited in any one of the independent claims defining the most generic part of the inventive concept are described as structural elements of a preferable embodiment, and are not absolutely necessary to overcome the problem according to the present invention.

### Embodiment 1

### (Configuration of the Display Apparatus)

Hereinafter, the configuration of the display apparatus according to Embodiment 1 of the present invention is described with reference to FIG. 1 through FIG. 4. FIG. 1 is a perspective view of the front of the display apparatus according to Embodiment 1 of the present invention. FIG. 2 is a perspective view of the back of the display apparatus shown in FIG. 1. FIG. 3 is a perspective view showing part of the internal structure of the display apparatus shown in FIG. 1. FIG. 4 is a cross section showing the relevant components in the display apparatus at the line A-A shown in FIG. 3.

The display apparatus 2 shown in the drawings includes a housing 4, a liquid crystal panel 6 (which includes the display panel) provided in the housing 4, and a backlight unit 8 provided in the housing 4. The display apparatus 2 according to Embodiment 1 is a liquid crystal television receiver equipped with the edge-lit backlight unit 8,

A front cabinet 10 and a rear cabinet 12 (which includes the support member) are put together to form the housing 4.

The front cabinet 10 is arranged on the front surface 6a side of the liquid crystal panel 6. The front cabinet 10 is formed in the shape of a frame and covers the outer peripheral portion of the liquid crystal panel 6. It should be noted that the front cabinet 10 is formed from, for example, resin.

The rear cabinet 12 is arranged facing the back surface 6b of the liquid crystal panel 6. The rear cabinet 12 slightly bulges out away from the liquid crystal panel 6 and includes a rectangular opening 12a to accommodate the liquid crystal panel 6. It should be noted that the rear cabinet 12 is formed from resin.

As FIG. 3 and FIG. 4 show, a plurality of integrally formed resin protrusions 14 for supporting a light guide plate 30 (to be described later) are provided on the internal, surface of the rear cabinet 12 (the surface of the rear cabinet 12 that faces the backlight unit 8). The protrusions 14 are arranged near a wiring substrate 40 (to be described later) and spaced apart from each other. In Embodiment 1, each protrusion 14 has roughly the shape of an elongated quadratic prism that extends in the longitudinal direction of the wiring substrate 40 (in the Y axis direction). Although not shown in the Drawings, it should be noted that among two opposing side portions of the rear cabinet 12, the protrusions 14 are provided not only at the side portion where the wiring substrate 40 is provided, but also provided at the other opposing side portion.

Furthermore, a plurality of bosses 16 for securing a heat sink 26 (to be described later) to the rear cabinet 12 are also provided on the internal surface of the rear cabinet 12. Each boss 16 includes a screw hole 20 which accepts a screw 18.

A power source substrate and such that supplies power to, for example, the liquid crystal panel 6 and the backlight unit 8, is attached to the central region of the external surface of the rear cabinet 12. A rear cover 22 is attached to the external surface of the rear cabinet 12. This rear cover 22 covers the above-described power source substrate and such. A stand 24 for supporting the housing 4 from below is attached to the bottom end portion of the rear cover 22. It should be noted that the rear cover 22 is formed from, for example, resin.

The backlight unit 8 is supported by the internal surface of the rear cabinet 12, as FIG. 3 and FIG. 4 show. The backlight unit 8 receives power from the above-described power supply substrate, and shines light toward the back surface 6b of the liquid crystal panel 6. The backlight unit 8 includes the heat sink 26, a light source 28, and the light guide plate 30.

The heat sink 26 includes a flat heat dissipation portion 32 and an attachment portion 34 which extends substantially vertical from one end portion of the heat dissipation portion 32 toward the liquid crystal panel 6. In other words, the heat sink 26 has a cross section that is substantially L-shaped. The heat dissipation portion 32 includes a plurality of holes 36 which correspond to the plurality of bosses 16. Each screw 18 passes through the hole 36 and screws into the screw hole 20 in the boss 16 to fasten the heat dissipation portion 32 to the internal surface of the rear cabinet 12. Elongated slits 38 extending in the Y axis direction are provided at the portions of the heat dissipation portion 32 that corresponds to the protrusions 14. The protrusions 14, which extend toward the liquid crystal panel 6, fit through their corresponding slits 38 and pass through the heat dissipation portion 32. It should be noted that the heat sink 26 is made from a metal having high thermal conductivity, such as aluminum.

The light source 28 includes a wiring substrate 40 and a plurality of LEDs 42 mounted on the wiring substrate 40. The wiring substrate 40 has an elongated plate-like shape. The LEDs 42 are arranged in a line in the longitudinal direction of the wiring substrate 40 and spaced apart from each other. The wiring substrate 40 is attached to the attachment portion 34 of the heat sink 26 with double sided tape 44 having heat transfer properties. Moreover, one side of the wiring substrate 40 (the bottom side in FIG. 4) is attached to the heat dissipation portion 32. As such, positioning of the light source 28 in the Z axis direction (the thickness direction of the display apparatus 2) is determined by the contact surface S1 of the wiring substrate 40 and the heat dissipation portion 32. It should be noted that the wiring substrate 40 is made from a metal having high thermal conductivity, such as aluminum.

The light guide plate 30 is supported by the protrusions 14 which pass through the heat dissipation portion 32. With this, positioning of the light guide plate 30 in the Z axis direction is determined by a contact surface S2 thereof with the protrusions 14. A reflective sheet 46 for reflecting light is attached to the back surface of the light guide plate 30. A side surface 30a of the light guide plate 30 is arranged to face the plurality of LEDs 114. A main surface 30b of the light guide plate 30 is arranged to face the back surface 6b of the liquid crystal panel 6.

The LEDs 42 light up and the light therefrom enters the light guide plate 30 through the side surface 30a. The light entering through the side surface 30a propagates into the light guide plate 30, reflects off the reflective sheet 46, and then is emitted from the main surface 30b toward the liquid crystal panel 6.

It should be noted that the LEDs 42 generate heat when they light up. The heat from the LEDs 42 is transferred to the heat dissipation portion 32 via the wiring substrate 40, the double sided tape 44, and the attachment portion 34. The heat transferred to the heat dissipation portion 32 is dissipated to the atmosphere.

As FIG. 4 shows, a guide member 48 for supporting the outer peripheral portion of the liquid crystal panel 6 from the back surface side of the liquid crystal panel 6 is arranged at an opening 12a of the rear cabinet 12. The guide member 48 has, for example, a frame shape. A first rib 50 is provided on the surface of the guide member 48 on the rear cabinet 12 side, and a second rib 52 is provided on the surface of the guide member 48 on the liquid crystal panel 6 side. The first rib 50 protrudes toward the rear cabinet 12 and the second rib 52 protrudes toward the liquid crystal panel 6. The first rib 50 is for applying pressing force on the outer peripheral portion of the light guide plate 30, toward the rear cabinet 12. This sandwiches and holds the outer peripheral portion of the light guide plate 30 between the first rib 50 and the protrusions 14. The second rib 52 is for securing a space the width of the liquid crystal panel 6 between the guide member 48 and a bezel 54 (to be described later).

The outer peripheral portion of the rectangular liquid crystal panel 6 is supported by the inner peripheral portion (the portion of the guide member 48 inward relative to the second rib 52) of the guide member 48. Light from the backlight unit 8 shines on the back surface 6b of the liquid crystal panel 6 whereby an image is displayed on the liquid crystal panel 6. The outer peripheral portion of the front surface 6a of the liquid crystal panel 6 is covered by the bezel 54. The bezel 54 has the shape of a frame and is fixed to the guide member 48 by a plurality of screws (not shown in the Drawings). This sandwiches the outer peripheral portion of the liquid crystal panel 6 between the bezel 54 and the guide member 48. It should be noted that the front cabinet 10 is attached to the rear cabinet 12 by a plurality of screws (not shown in the Drawings) so that the front cabinet 10 covers the bezel 54 and the guide member 48.

### (Advantageous Effects)

Next, the advantageous effects of the display apparatus 2 according to Embodiment 1 will be described. Positioning of the light source 28 in the Z axis direction is determined by the contact surface S1 of the wiring substrate 40 and the heat dissipation portion 32 and positioning of the light guide plate 30 in the Z axis direction is determined by the contact surface S2 thereof with the plurality of protrusions 14 such that the optical axis C1 of each LED 42 (in other words, the optical axis C1 a the light source 28) and the optical axis C2 of the light guide plate 30 are aligned.

The dimensions pertinent to aligning the optical axis C1 of each LED 42 and the optical axis C2 of the light guide plate 30 are the dimensions D1 through D5 shown in FIG. 4. The dimension D1 is the thickness of the light guide plate 30. The dimension D2 is the thickness of the reflective sheet 46. The dimension D3 is the height of the protrusion 14 measured from the bottom surface of the heat dissipation portion 32 in the Z axis direction. The dimension D4 is the thickness of the heat dissipation portion 32. The dimension D5 is the distance between the top surface of the heat dissipation portion 32 and the optical axis C1.

As described above, each protrusion 14 is integrally formed with the rear cabinet 12 from resin. This makes it possible to form the protrusions 14 with a relatively high degree of accuracy, For this reason, the tolerance for the dimension D3 can be reduced to a relatively small range. This in turn means that the tolerance stack for the dimensions D1 through D5 can be reduced to a relatively small range, and a discrepancy in the position of the light guide plate 30 in the Z axis direction can be reduced, thereby minimizing a misalignment of the optical axis C1 of each LED 42 and the optical axis C2 of the light guide plate 30.

### Embodiment 2

Next, the configuration of the display apparatus according to Embodiment 2 of the present invention is described with reference to FIG. 5 and FIG. 6. FIG. 5 is a perspective view showing part of the internal structure of the display apparatus according to Embodiment 2 of the present invention. FIG. 6 is a cross section showing the relevant components in the display apparatus at the line B-B shown in FIG. 5. Hereinafter, the differences between the display apparatus 2A according to Embodiment 2 and the display apparatus 2 according to Embodiment 1 will be described.

With the display apparatus 2A according to Embodiment 2, the length of a protrusion 14A in the Y axis direction is shorter than the length of the protrusion 14 according to Embodiment 1 in the Y axis direction. With this, since the size of the plurality of slits 38A is smaller, it possible to increase the heat transferability from the attachment portion 34 to a heat dissipation portion 32A, whereby effective heat dissipation of the LEDs 42 can be achieved.

Furthermore, as FIG. 6 shows, a portion of the edge 14Aa of the surface of the protrusion 14A in contact with the light guide plate 30 is rounded, This eliminates contact between the edge 14a and the reflective sheet 46, thereby making the pressing force at the contact surface of the protrusion 14 and the light guide plate 30 relatively small, Since the pressing force at the contact surface of the protrusion 14A and the light guide plate 30 becomes relatively small, the phenomenon in which luminance at the location of the contact surface on the liquid crystal panel 6 increases—known as the white spot phenomenon—can be kept to a minimum.

Also, a bend preventing member 60 is attached to the portion of the heat dissipation portion 32A between two adjacent protrusions 14A. The elongated bend preventing member 60 is made from, for example, urethane, and extends in the longitudinal direction of the wiring substrate 40. The height of the bend preventing member 60 in the Z axis direction is designed to be slightly shorter than the height of the protrusion 14A measured from the top surface of the heat dissipation portion 32A in the Z axis direction. The bend preventing member 60 configured in this manner is capable of preventing the light guide plate 30 from bending between adjacent protrusions 14A toward the heat dissipation portion 32A.

Additionally, a spacer 62 is provided on the side surface of the protrusion 14A on the side of the wiring substrate 40, The spacer 62 is formed integrally with the protrusion 14A from resin. The spacer 62 is situated between the wiring substrate 40 and the side surface 30a of the light guide plate 30. The thickness (in other words, the length in the X axis direction) of the spacer 62 is greater than the thickness of the LED 42. With this, it is possible to keep the LEDs 42 and the side surface 30a of the light guide plate 30 at a constant distance (gap) and stabilize the light utilization efficiency.

It should be noted that in Embodiment 2, the spacer 62 is formed integrally with the protrusion 14A, but the spacer 62 may be provided as a separate component. In the case that the spacer 62 is provided as a separate component, the spacer 62 is attached to the protrusion 14A with an adhesive, double sided tape, or a screw, for example.

### Embodiment 3

Next, the configuration of the display apparatus according to Embodiment 3 of the present invention is described with reference to FIG. 7. FIG. 7 is a cross section showing the relevant components in the display apparatus according to Embodiment 3 of the present invention.

Display apparatus 2B according to Embodiment 3 is configured such that a heat dissipation portion 328 of a heat sink 268 is not provided with the slit 38 described above in Embodiment 1. A retaining member 70 for supporting the light guide plate 30 is attached to the heat dissipation portion 32B. The retaining member 70 is made from, for example, a resin, such as polycarbonate. Since the retaining member 70 is situated between the light guide plate 30 and the heat dissipation portion 328, positioning of the light guide plate 30 in the Z axis direction is determined by the contact surface S2 thereof with the retaining member 70. It should be noted that a portion of an edge 70a of the surface of the retaining member 70 in contact with the light guide plate 30 is rounded, similar to Embodiment 2.

Instead of the first rib 50 described in Embodiment 1, a cushion 72 is attached to the surface of a guide member 48B on the rear cabinet 12 side. The cushion 72 is made from, for example, an elastic material, such as rubber. This sandwiches and holds the outer peripheral portion of the light guide plate 30 between the cushion 72 and the retaining member 70.

With the display apparatus 28 according to Embodiment 3, it is possible to form the retaining member 70 with a relatively high degree of accuracy since the retaining member 70 is made from resin. This means a discrepancy in the position of the light guide plate 30 in the Z axis direction can be reduced, thereby minimizing a misalignment of the optical axis C1 of each LED 42 and the optical axis C2 of the light guide plate 30, similar to Embodiment 1.

### Embodiment 4

Next, the configuration of the display apparatus according to Embodiment 4 of the present invention is described with reference to FIG. 8. FIG. 8 is a cross section showing the relevant components in the display apparatus according to Embodiment 4 of the present invention.

Display apparatus 2C according to Embodiment 4 has a retaining member 70C which differs in shape to the retaining member 70 according to Embodiment 3. More specifically, the retaining member 70C includes a first retaining portion 70Cb and a second retaining portion 70Cc which extends from the bottom of one end of the first retaining portion 70Cb toward the wiring substrate 40. The height of the first retaining portion 70Cb in the Z axis direction is greater than the height of the second retaining portion 70Cc in the Z axis direction. The first retaining portion 70Cb is situated between the light guide plate 30 and the heat dissipation portion 32B, and supports the light guide plate 30. The second retaining portion 70Cc is situated between the wiring substrate 40 and the heat dissipation portion 323, and supports the wiring substrate 40. It should be noted that a portion of an edge 70Ca of the surface of the first retaining portion 70Cb in contact with the light guide plate 30 is rounded, similar to Embodiment 3.

As such, with Embodiment 4, positioning of the LEDs 42 in the Z axis direction is determined by the contact surface S1 of the wiring substrate 40 and the second retaining portion 70Cc, and positioning of the light guide plate 30 in the Z axis direction is determined by the contact surface S2 thereof with the first retaining portion 70Cb. It is possible to form the retaining member 70C with a relatively high degree of accuracy since the retaining member 70C is made from resin. With this, Embodiment 4 has the same advantageous effects as Embodiment 1.

The display apparatus has hereinbefore been described according to Embodiments 1 through 4 of the present invention, but the present invention is not limited to these embodiments. For example, the above embodiments may be arbitrarily combined.

In each of the above embodiments, the display apparatus is exemplified as a liquid crystal television receiver, but the display apparatus may be, for example, a liquid crystal monitor for a computer.

In each of the above embodiments, LEDs were used as a light source for the backlight unit, but a cold cathode fluorescent lamp (CCFL), for example, may be used.

In each of the above embodiments, the support member is the rear cabinet, but the support member may be a resin member that is separate from the rear cabinet. In this case, the support member is attached to the internal surface of the rear cabinet with screws, for example.

In Embodiments 1 and 2, a plurality of the protrusions are used, but it is possible to only use a single protrusion.

In Embodiments 2 through 4, a portion of the edge is rounded, but the whole edge may be rounded.

### INDUSTRIAL APPLICABILITY

The display apparatus according to the present invention is applicable as, for example, a liquid crystal television receiver or a computer liquid crystal monitor.

1. A display apparatus comprising:
a display panel;
a resin support member facing a back surface of the display panel; and
a backlight unit that is supported by the support member and emits light toward the back surface of the display panel, the backlight unit including:
a light source that generates the light;
a light guide plate including a side surface through which the light generated by the light source enters and a main surface through which the light entering through the side surface exits toward the back surface of the display panel; and
a heat sink supported by the support member and to which the light source is attached,
wherein the support member includes an integrally formed resin protrusion passing through the heat sink and supporting the light guide plate, and
positioning of the light source is determined by a contact surface thereof with the heat sink and positioning of the light guide plate is determined by a contact surface thereof with the protrusion so that optical axes of the light source and the light guide plate are aligned.

2. The display apparatus according to claim 1,
wherein the heat sink includes:
a heat dissipation portion supported by the support member; and
an attachment portion that extends from an end portion of the heat dissipation portion toward the display panel and to which the light source is attached,
the protrusion passes through the heat dissipation portion and supports the light guide plate, and
positioning of the light source is determined by a contact surface thereof with the heat dissipation portion.

3. The display apparatus according to claim 1,
wherein the protrusion includes a spacer disposed between the light source and the side surface of the light guide plate.

4. The display apparatus according to claim 1,
wherein the protrusion has a surface in contact with the light guide plate, and at least a portion of an edge of the surface is rounded.

5. The display apparatus according to claim 1,
wherein the support member includes a plurality of the protrusions, and
the plurality of the protrusions are spaced apart from each other.

6. The display apparatus according to claim 5,
wherein a bend preventing member for preventing the light guide plate from bending toward the heat sink is provided on the heat sink between two adjacent ones of the plurality of the protrusions.

7. The display apparatus according to claim 1, further comprising
a housing containing the display panel and the backlight unit,
wherein the housing includes:
a front cabinet arranged on a side of the display apparatus that the display panel is situated; and
a rear cabinet arranged on a side of the display apparatus that the backlight unit is situated, and
the support member the rear cabinet.
